(19) United States
(12) Patent Application Publication
(10) Pub. No.: US 2025/0269958 A1
(43) Pub. Date: Aug. 28, 2025

(54) SYSTEM FOR DISCHARGING A LIQUID COMPONENT FROM A REMOTE OPERATED VEHICLE

(71) Applicant: Lucid Bots, Inc., Charlotte, NC (US)

(72) Inventors: Andrew ASHUR, Huntersville, NC (US); Jeremy ALLEN, Monreo, NC (US); William RECHER, Rincon, GA (US)

(73) Assignee: Lucid Bots, Inc., Charlotte, NC (US)

(21) Appl. No.: 19/053,517

(22) Filed: Feb. 14, 2025

Related U.S. Application Data
(60) Provisional application No. 63/556,451, filed on Feb. 22, 2024.

(51) Int. Cl. B64D 1/18; B08B 3/02

(52) U.S. Cl. CPC B64D 1/18; B08B 3/024; B08B 2203/0217; B08B 2203/0223

(57) ABSTRACT

A system for discharging a liquid component from a remote operated vehicle includes the remote operated vehicle, a valve system, a pressure device, a liquid source, and a discharge nozzle. The valve system is attached to the top surface and/or the bottom surface of the platform, and includes a valve and a servo actuator. The valve includes a valve body, a valve disc within an interior of the valve body, and a stem attached to the valve disc and extending outside of the valve body. The servo actuator operatively connects to the stem. The pressure device includes a device inlet fluidly connected to the liquid source and a device outlet fluidly connected to a valve body inlet. The discharge nozzle is fluidly connected to a valve body outlet. The servo actuator is configured to operate on the valve stem to move the valve disc in a range of a fully open position and a fully closed position.

### CROSS REFERENCES AND PRIORITIES

This Application claims priority from U.S. Provisional Application No. 63/556,451 filed on 22 Feb. 2024, the teachings of which are incorporated by reference herein in their entirety.

### BACKGROUND

The use of remote operated vehicles-such as aerial drones and ground operated robots-to apply liquids to buildings and structures from a pressurized liquid source is known.

United States Patent Publication 2019/0168875 discloses a drone cleaning apparatus that includes a drone; and a pressure washer or power washer comprising a wand with nozzle, hose, and motor unit. The wand is fastened to an underside of the drone, with the hose attached to the wand and connecting the wand to the motor unit. When the motor unit is turned on, a liquid jet emanates from the nozzle of the wand and may be directed onto a building for cleaning the building. A method of making the drone cleaning apparatus, comprises: providing a drone and a pressure washer or power washer comprising a wand with nozzle, hose, and motor unit; attaching the wand to a bottom of the drone; and connecting the hose to the wand and to the motor unit.

Existing methods and systems of applying liquids via a remote operated vehicle typically rely upon a pressure source located at ground level to initiate and stop the flow of liquid to the drone for discharging onto the building or structure. Often, these pressure sources are a pump which must be turned on or off by a user at ground level which can interfere with operation of the remote operated vehicle—in particular when the user is also tasked with operating the controls for the remote operated vehicle. Often, the solution amounts to requiring two users. One to operate the remote operated vehicle, and another to turn the pump on or off.

The need exists, therefore, for an improved system and method for controlling the discharge of liquids from a remote operated vehicle.

### SUMMARY

Described herein is a system for discharging a liquid component from a remote operated vehicle. The system includes the remote operated vehicle, a valve system, a pressure device, a liquid source, and a discharge nozzle.

The valve system is attached to the remote operated vehicle and includes a valve and a servo actuator. The valve includes a valve body having a valve body inlet and a valve body outlet, a valve disc located within an interior of the valve body, and a stem attached to the valve disc and extending outside of the valve body. The servo actuator is operatively connected to the stem. The servo actuator is configured to operate on the stem to move the valve disc in a range of a fully open position and a fully closed position.

The pressure device includes a device inlet and a device outlet with the device outlet being fluidly connected to the valve body inlet. The liquid source is fluidly connected to the device inlet. The discharge nozzle is fluidly connected to the valve body outlet.

In some embodiments, the system includes a platform comprising a platform top surface and a platform bottom surface. In certain such embodiments, the valve system may be attached to the platform top surface and/or the platform bottom surface. When present, the platform may be connected to the remote operated vehicle.

In certain embodiments, the servo actuator may be configured to receive a wireless signal from a remote device to operate on the stem to move the valve disc in the range of the fully open position and the fully closed position. In certain embodiments, the servo actuator may turn the stem and thereby rotate the valve disc within the valve body. In other embodiments, the servo actuator may act on the stem to raise or lower the valve disc within the valve body.

In some embodiments, the valve disc may be selected from the group consisting of a disc, a needle, a gate, a rotary ball, and a plug.

In certain embodiments, the pressure device may be attached to the remote operated vehicle. The pressure device may be configured to allow liquid to exit the discharge nozzle at a pressure in a range of between 100 psi and 5,000 psi when the valve disc is in an opened position in a range of between the fully open position to the fully closed position which is inclusive of the fully open position, but exclusive of the fully closed position.

In some embodiments, the pressure device may be selected from the group consisting of a diaphragm pump, a rotary pump, a piston pump, and a centrifugal pump. The pressure device may be driven by a motor.

In some embodiments, the liquid source may be a tank. When present, the tank may be attached to the remote operated vehicle in certain embodiments. In other embodiments, the liquid source may be a water spigot connected to a well or a municipal water line.

In certain embodiments, the liquid may comprise water. The liquid may further comprise at least one cleaning agent.

In some embodiments, the remote operated vehicle may be an aerial drone. In other embodiments, the remote operated vehicle may be a ground robot.

### BRIEF DESCRIPTION OF FIGURES

FIG. 1 illustrates a perspective view of a system for discharging a liquid component.

FIG. 2 illustrates an exploded perspective view of the system of FIG. 1.

FIG. 3 illustrates an exploded side view of a system for discharging a liquid component.

FIG. 4 illustrates a top view of a system for discharging a liquid component.

FIG. 5 illustrates a perspective view of a remote operated vehicle which is an aerial drone with a system for discharging a liquid component attached thereto.

FIG. 6A illustrates a side cross section view of one embodiment of a valve for a system for discharging a liquid component with the valve in an open position.

FIG. 6B illustrates a side cross section view of one embodiment of a valve for a system for discharging a liquid component with the valve in an closed position.

FIG. 7A illustrates a side cross section view of one embodiment of a valve for a system for discharging a liquid component with the valve in an open position.

FIG. 7B illustrates a side cross section view of one embodiment of a valve for a system for discharging a liquid component with the valve in a closed position.

FIG. 8 illustrates a perspective view of a ground robot having a system for discharging a liquid component.

FIG. 9 illustrates an exploded perspective view of the ground robot of FIG. 8.

### DETAILED DESCRIPTION

Disclosed herein is a system for discharging a liquid component from a remote operated vehicle. As described herein and in the claims, the following numbers refer to the following structures as noted in the Figures.
10 refers to a system (for discharging a liquid component from a remote operated vehicle).
100 refers to a remote operated vehicle.
110 refers to a platform.
111 refers to a platform top surface.
112 refers to a platform bottom surface.
200 refers to a valve system.
210 refers to a valve (of the valve system).
211 refers to a valve body.
212 refers to a valve body inlet.
213 refers to a valve body outlet.
214 refers to a valve disc.
215 refers to a stem.
220 refers to a servo actuator.
300 refers to a pressure device.
310 refers to a device inlet.
320 refers to a device outlet.
400 refers to a liquid source.
500 refers to a discharge nozzle.
600 refers to a remote device.

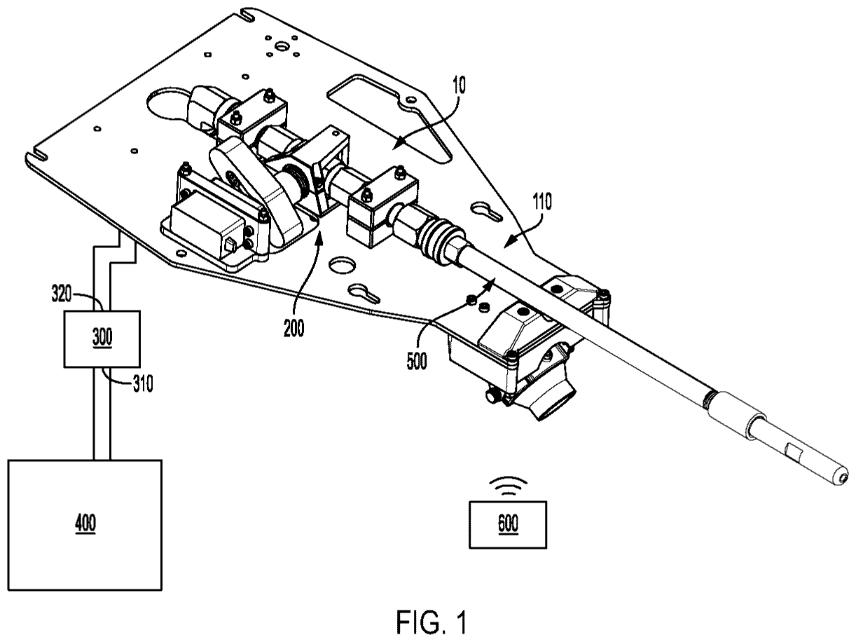

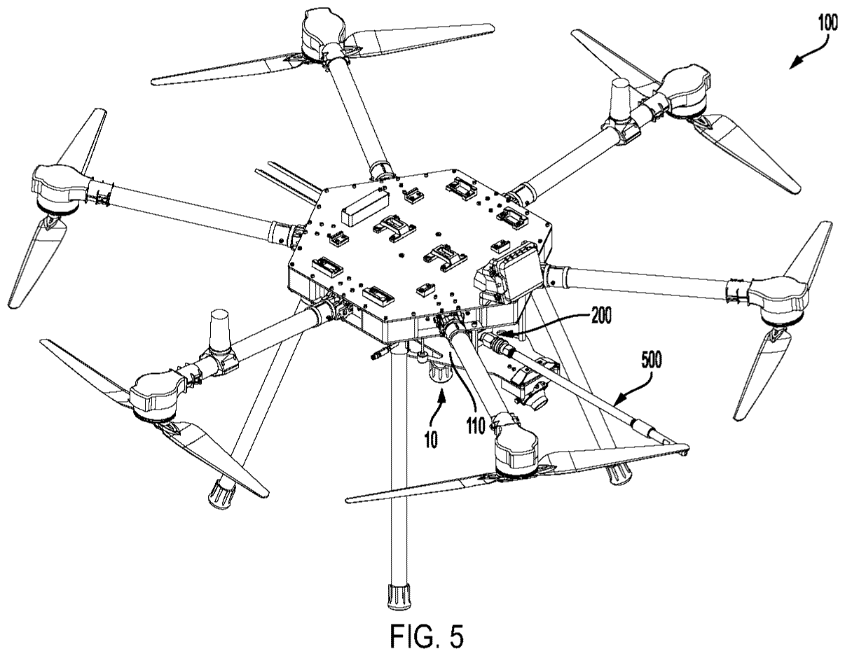

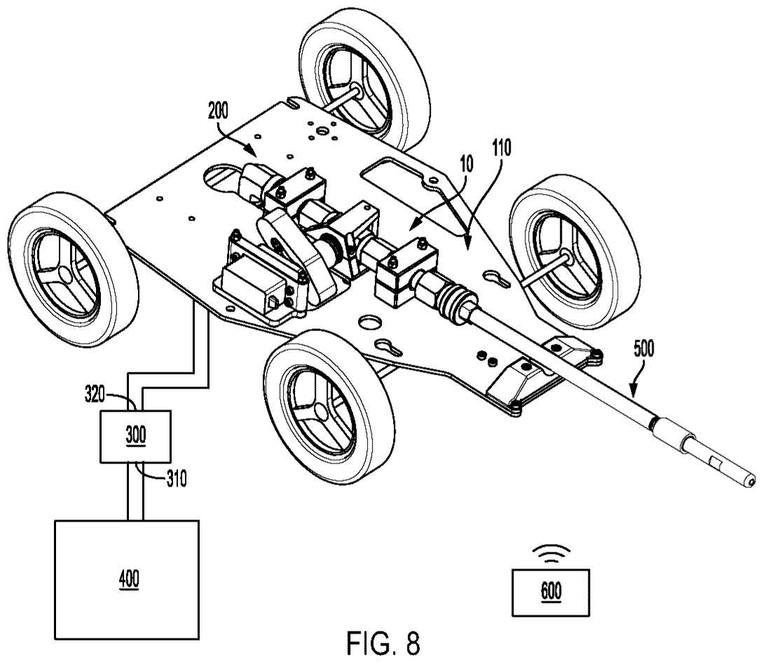

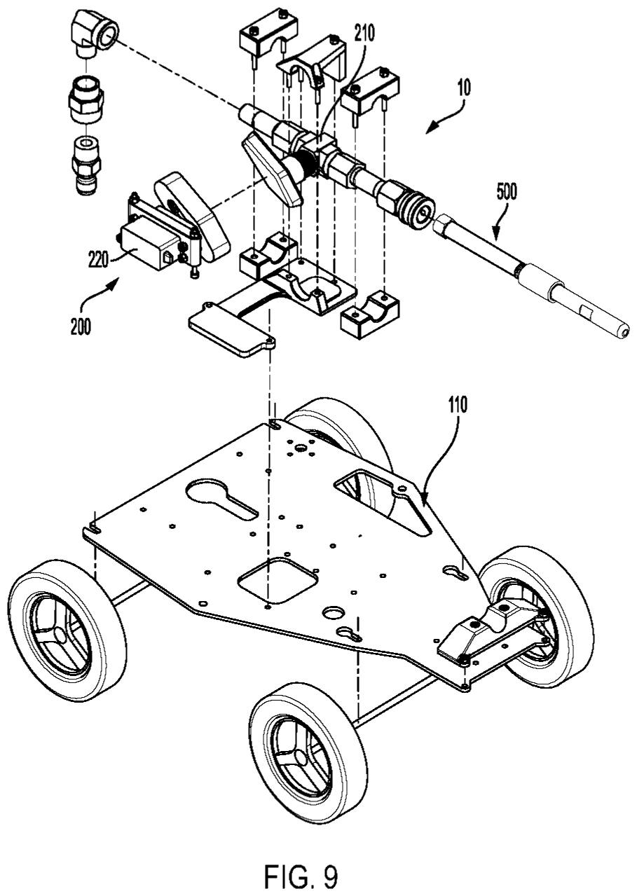

FIG. 1 illustrates a perspective view of a system (10) for discharging a liquid component from a remote operated vehicle ((100) as shown in FIG. 5, FIG. 8, and FIG. 9). As shown in FIG. 1, the system includes a valve system (200), a pressure device (300), a liquid source (400), and a discharge nozzle (500).

The system (10) may include a platform (110) to which various components may be attached. In particular, when the platform is present, it is preferred that the valve system (200) be attached to the platform.

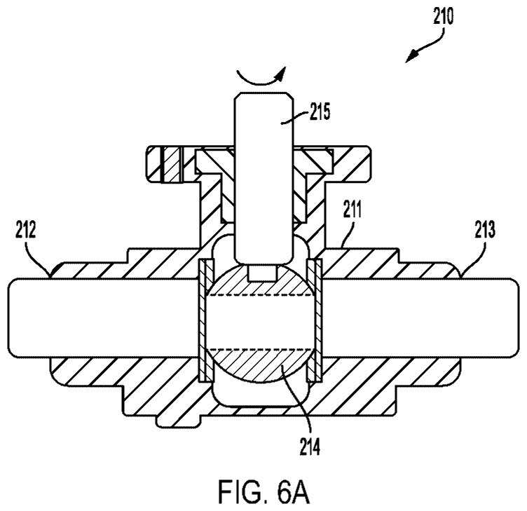

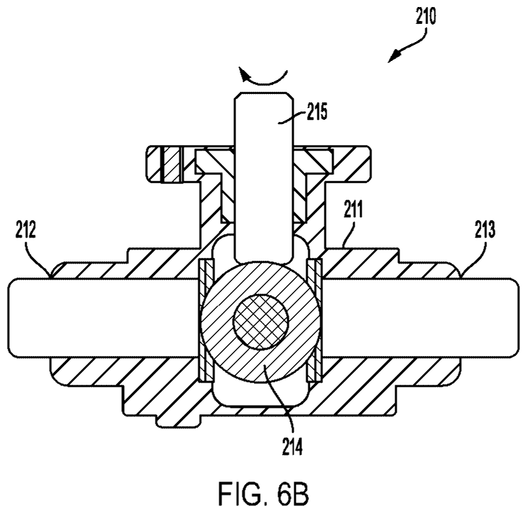

The pressure device (300)—which may be a liquid pump of any number of types known in the art—includes a device inlet (310) and a device outlet (320) as shown in FIG. 1. The device inlet being fluidly connected to the liquid source (400) by a line, hose, or similar conduit; and the device outlet being fluidly connected to a valve body inlet ((212) as shown in FIGS. 5A through 6B) also by a line, hose, or similar conduit. The pressure device may be attached to the remote operated vehicle or may be a separate component from the remote operated vehicle as shown in FIG. 1. In addition to, or instead of a liquid pump, the pressure device may comprise a source of compressed fluid.

Non-limiting examples of a pressure device include a diaphragm pump, a rotary pump, a piston pump, a centrifugal pump, and the like. Such pumps may be driven by a motor such as an internal combustion engine or an electric motor. The pressure device may be configured to allow for discharge of the liquid from the discharge nozzle at low pressure or high pressure. Low pressure applications will generally involve discharge of the liquid from the discharge nozzle at a pressure of at least 100 psi and as much as 750 psi and a volume of at least 2.5 gallons per minute and as much as 12.5 gallons per minute. That is to say that the discharge pressure in low pressure applications may be in any range between 100 psi and 750 psi while the discharge volume in low pressure applications may be in any range between 2.5 gallons per minute and 12.5 gallons per minute. In high pressure applications, discharge of the liquid from the discharge nozzle may occur at a pressure of at least 3,000 psi and as much as 5,000 psi at a volume of at least 5 gallons per minute and as much as 15 gallons per minute. That is to say that the discharge pressure in high pressure applications may be in any range between 3,000 psi and 5,000 psi while the discharge volume in high pressure applications may be in any range between 5 gallons per minute and 15 gallons per minute.

In some embodiments, the liquid source (400) may be a tank which holds a liquid. Alternatively, the liquid source may be a water spigot connected to a well or municipal water line. Preferably, the liquid will comprise water while—in certain embodiments—the liquid may further comprise at least one cleaning agent. When a cleaning agent is present, the cleaning agent may be selected from the group consisting of potassium hydroxide, sodium hydroxide, sodium hypochlorite, degreasers, rust-removal compounds, ammonia, citric acid, muriatic acid, oxalic acid, calcium remover, efflorescence remover, vinegar, surfactants, graffiti remover, wasp and hornet killer, spider control chemicals, concrete sealers, stain remover, concrete cleaner, brick cleaner, shingle cleaner, vinyl cleaner, metal surface cleaner, roof cleaner, and wood cleaner. When a cleaning agent is present, it may be added to the liquid within the liquid source or it may be added from a separate cleaning agent source which may be connected to the pressure device (300).

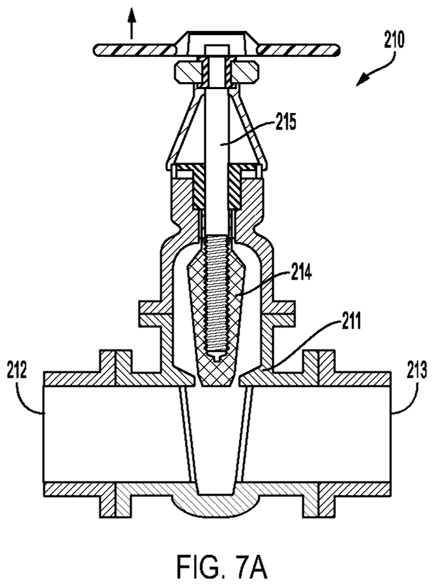

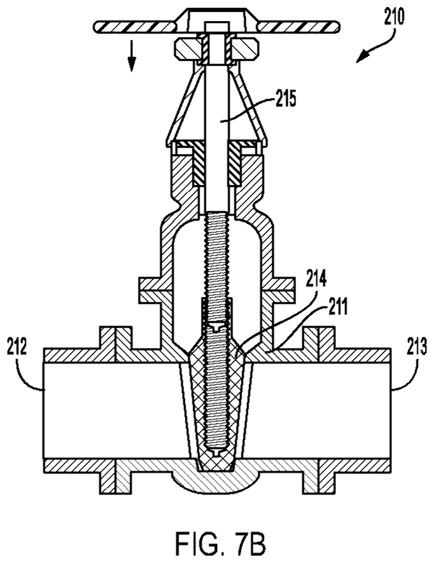

The discharge nozzle (500)—which may be any form of nozzle commonly used for spraying a liquid at high pressure—is fluidly connected to the valve body outlet ((213) as shown in FIGS. 6A through 7B). Preferably, the discharge nozzle will be attached to the platform (110) as shown in FIG. 1.

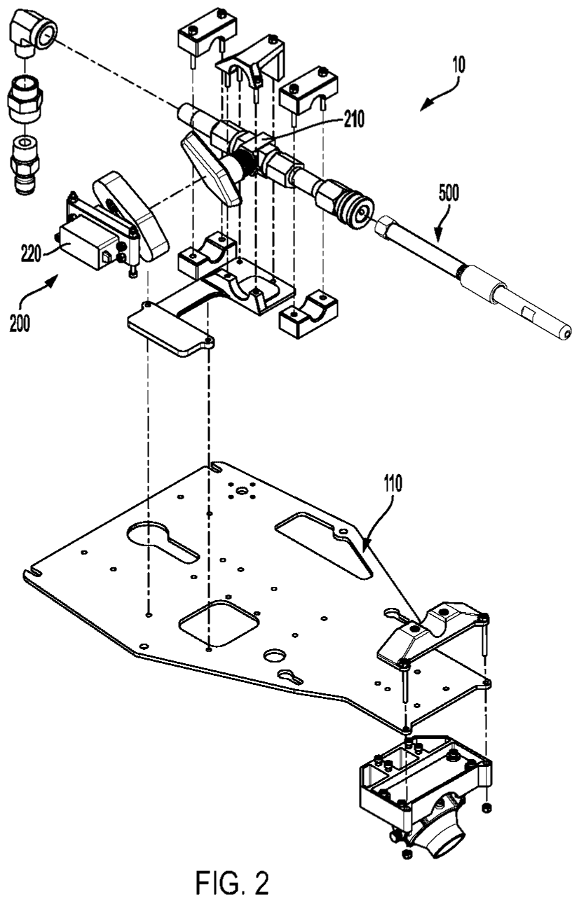

FIG. 2 illustrates an exploded perspective view of the system (10) shown in FIG. 1 including further details of the valve system (200). As shown in FIG. 2, the valve system includes a valve (210) and a servo actuator (220). The servo actuator being configured to receive a wireless signal from a remote device ((600) as shown in FIG. 1) interacting with a radio control receiver which is integrated into the servo actuator to operate on the valve. The servo actuator includes a power source—such as a battery—which provides a source of electrical power to operate on the valve as described herein upon receiving the wireless signal from the remote device.

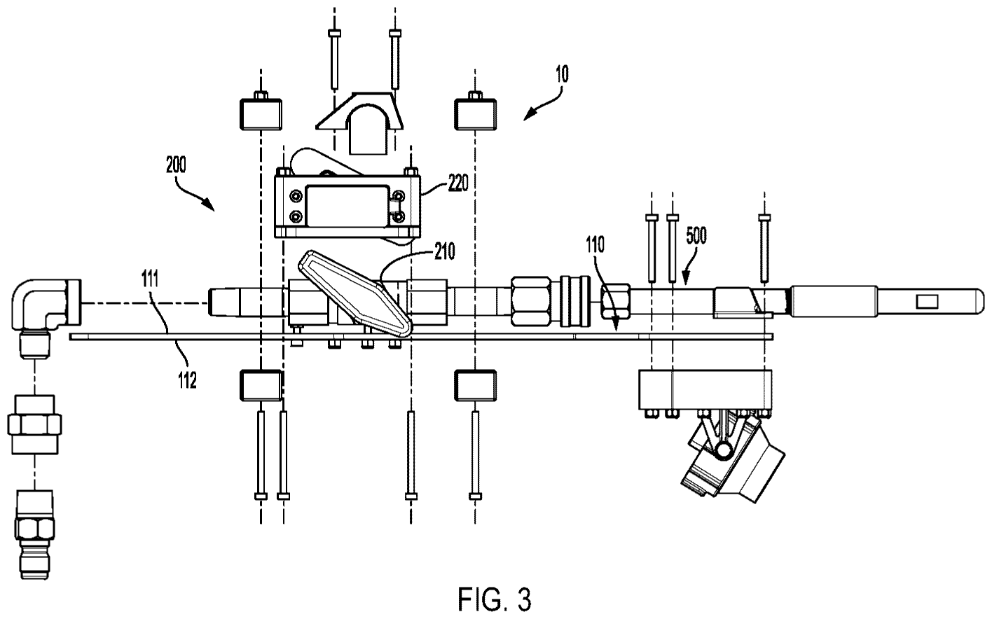

FIG. 3 illustrates an exploded side view of the system (10) shown in FIG. 1 including further details of the platform (110). As shown in FIG. 3, the platform includes a platform top surface (111) and a platform bottom surface (112). The various components of the system—including the valve system (200), the valve (210), the servo actuator (220), the discharge nozzle (500), and (when incorporated into the remote operated vehicle) the pressure device (300)—may be attached to a portion of either or both of the platform top surface and the platform bottom surface. Attachment of these components may be achieved by any number of means including by way of one or more fasteners (such as bolts, screws, rivets, clamps, or the like), an adhesive, a tape, and combinations thereof.

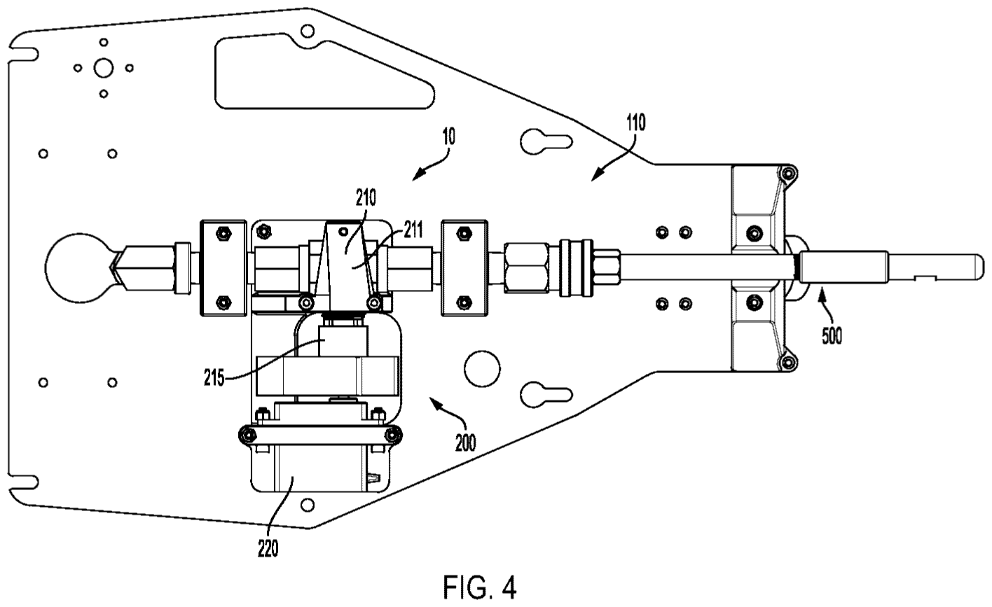

FIG. 4 illustrates a top view of the system (10) shown in FIG. 1 including further details of the valve system (200). As shown in FIG. 4, the valve system includes a valve (210) having a stem (215) extending therefrom. The stem is operatively connected to the servo actuator (220) such that—when the servo actuator receives a wireless signal from the remote device ((600) as shown in FIG. 1) via a radio control receiver which is integrated into the servo actuator, the servo actuator operates on the stem to open and close the valve.

FIG. 5 illustrates a perspective view of the system (10) connected to a remote operated vehicle (100). In this case, the remote operated vehicle is an aerial drone having a plurality of propellers powered by a battery which—when activated—provide a lifting force that allows the remote operated vehicle to fly and hover above the ground. The aerial drone may be controlled by receiving a signal from a remote device ((600) as shown in FIG. 1) which may be the same remote device which controls the system.

FIGS. 6A and FIG. 6B illustrate a side cross-section of one embodiment of a valve (210) which may be utilized in the valve system ((200) as shown in FIG. 1) with FIG. 6A showing the valve in a fully open position and FIG. 6B showing the valve in a fully closed position. In general, the valve will include a valve body (211) having a valve body inlet (212) and a valve body outlet (213). A valve disc (214) located within an interior of the valve body will be attached to a stem (215) that extends outside of the valve body and operatively connects to the servo actuator ((220) as shown in FIG. 4).

In the embodiment shown in FIG. 6A and FIG. 6B, the valve (210) takes the form of a full port ball valve in which the valve disc (214) is a rotary ball having a hole disposed through a central axis thereof. In operation, the servo actuator ((220) as shown in FIG. 4) operates on the stem (215) to turn the stem and thereby rotate the valve disc (214) (in this case being a rotary ball) within the valve body (211) between the valve fully open position shown in FIG. 6A and the valve fully closed position shown in FIG. 6B. While FIG. 6A and FIG. 6B show the valve in the fully open position (FIG. 6A) and the fully closed position (FIG. 6B) respectively, one will recognize that the servo actuator may operate on the stem to turn the stem and thereby rotate the valve disc to any position between the fully open position and the fully closed position—which may also be referred to as a partially open or partially closed position.

FIGS. 7A and FIG. 7B illustrate a side cross-section of another embodiment of a valve (210) which may be utilized in the valve system ((200) as shown in FIG. 1) with FIG. 7A showing the valve in a fully open position and FIG. 7B showing the valve in a fully closed position. In the embodiment shown in FIG. 7A and FIG. 7B, the valve takes the form of a gate valve in which the valve disc (214) is a gate having a hole disposed through the wall thereof. In operation, the servo actuator ((220) as shown in FIG. 4) operates on the stem (215) to raise or lower the valve disc (214) (in this case being a gate) within the valve body (211) between the valve fully open position shown in FIG. 7A and the valve fully closed position shown in FIG. 7B. While FIG. 7A and FIG. 7B show the valve in the fully open position (FIG. 7A) and the fully closed position (FIG. 7B) respectively, one will recognize that the servo actuator may operate on the stem to turn the stem and thereby raise and lower the valve disc to any position between the fully open position and the fully closed position—which may also be referred to as a partially open or partially closed position.

While FIGS. 6A and 6B illustrate a full port ball valve, and FIGS. 7A and 7B illustrate a gate valve, other valve embodiments may exist. Nonlimiting examples of such valves include a disc valve, a needle valve, and a plug valve. Accordingly, the valve disc (214) may be selected from the group consisting of a disc, a needle, a gate, a rotary ball, and a plug.

When the valve disc is in an opened position in a range of between the fully open position to the fully closed position—inclusive of the fully open position, but exclusive of the fully closed position—the liquid is allowed to exit the discharge nozzle ((500 as shown in FIG. 1) at pressure applied via the pressure device ((300) as shown in FIG. 1). Said pressure may be in a range of between 100 psi and 5,000 psi.

FIG. 8 and FIG. 9 illustrate an alternative remote vehicle for the system (10) for discharging a liquid component. In the system illustrated in FIG. 8 and FIG. 9, the remote operated vehicle takes the form of a ground robot having one or more wheels—operated by one or more motors (not shown) and powered by one or more power sources such as a battery (also not shown)—which allow the remote operated vehicle to be maneuvered over ground surface based on inputs provided by the remote device (600). The ground robot illustrated in FIGS. 8 and 9 may include any or all of the features previously noted with respect to the aerial drone illustrated in FIG. 1 through FIG. 4 including a platform (110), a valve system (200) including a valve (210) and a servo actuator (220), a pressure device (300), a liquid source (400), and a discharge nozzle (500).

The invented systems with a servo actuator and valve system incorporated into the drone and operated by a remote device allows a single user to control the discharge of liquid from the remote operated vehicle while simultaneously operating the remote operated vehicle using the same remote device.

While the system has been described as having one or more exemplary designs, the present system may be further modified within the spirit and scope of this disclosure. This application is therefore intended to cover any variations, uses, or adaptations of the system disclosed herein using their general principles.

What is claimed is:

1. A system (10) for discharging a liquid component from a remote operated vehicle (100), said system comprising:
the remote operated vehicle;
a valve system (200) attached to the remote operated vehicle, said valve system comprising:
a valve (210) comprising:
a valve body (211) having a valve body inlet (212) and a valve body outlet (213),
a valve disc (214) located within an interior of the valve body, and
a stem (215) attached to the valve disc and extending outside of the valve body, and
a servo actuator (220) operatively connected to the stem;
a pressure device (300) having a device inlet (310) and a device outlet (320), said device outlet being fluidly connected to the valve body inlet;
a liquid source (400) fluidly connected to the device inlet; and
a discharge nozzle (500) fluidly connected to the valve body outlet; and
wherein the servo actuator is configured to operate on the stem to move the valve disc in a range of a fully open position and a fully closed position.

2. The system of claim 1, wherein the system includes a platform (110) comprising a platform top surface (111) and a platform bottom surface (112), wherein the valve system is attached to the platform top surface and/or the platform bottom surface, and wherein the platform is connected to the remote operated vehicle.

3. The system of claim 1, wherein the servo actuator is configured to receive a wireless signal from a remote device (600) to operate on the stem to move the valve disc in the range of the fully open position and the fully closed position.

4. The system of claim 1, wherein the valve disc is selected from the group consisting of a disc, a needle, a gate, a rotary ball, and a plug.

5. The system of claim 1, wherein the servo actuator is configured to turn the stem and thereby rotate the valve disc within the valve body.

6. The system of claim 1, wherein the servo actuator is configured to act on the stem to raise or lower the valve disc within the valve body.

7. The system of claim 1, wherein the pressure device is configured to allow the liquid to exit the discharge nozzle at a pressure in a range of between 100 psi and 5,000 psi when the valve disc is in an opened position in a range of between the fully open position to the fully closed position which is inclusive of the fully open position, but exclusive of the fully closed position.

8. The system of claim 1, wherein the pressure device is selected from the group consisting of a diaphragm pump, a rotary pump, a piston pump, and a centrifugal pump.

9. The system of claim 8, wherein the pressure device is driven by a motor.

10. The system of claim 1, wherein the liquid source is a tank.

11. The system of claim 1, wherein the liquid source is a water spigot connected to a well or a municipal water line.

12. The system of claim 1, wherein the liquid comprises water.

13. The system of claim 12, wherein the liquid further comprises at least one cleaning agent.

14. The system of claim 2, wherein the servo actuator is configured to receive a wireless signal from a remote device (600) to operate on the stem to move the valve disc in the range of the fully open position and the fully closed position.

15. The system of claim 2, wherein the valve disc is selected from the group consisting of a disc, a needle, a gate, a rotary ball, and a plug.

16. The system of claim 2, wherein the servo actuator is configured to turn the stem and thereby rotate the valve disc within the valve body.

17. The system of claim 2, wherein the servo actuator is configured to act on the stem to raise or lower the valve disc within the valve body.

18. The system of claim 2, wherein the pressure device is configured to allow the liquid to exit the discharge nozzle at a pressure in a range of between 100 psi and 5,000 psi when the valve disc is in an opened position in a range of between the fully open position to the fully closed position which is inclusive of the fully open position, but exclusive of the fully closed position.

19. The system of claim 1, wherein the remote operated vehicle is an aerial drone.

20. The system of claim 1, wherein the remote operated vehicle is a ground robot.
